(19) United States
(12) Patent Application Publication
(10) Pub. No.: US 2025/0050712 A1
(43) Pub. Date: Feb. 13, 2025

(54) FRAMED SHADE CASSETTE WINDOW ENCLOSURE

(71) Applicant: Lippert Components, Inc., Elkhart, IN (US)

(72) Inventors: Toby CROWLEY, Syracuse, IN (US); Phats XAYAMATH, Granger, IN (US)

(21) Appl. No.: 18/773,877

(22) Filed: Jul. 16, 2024

Related U.S. Application Data
(60) Provisional application No. 63/514,003, filed on Jul. 17, 2023.

(51) Int. Cl. B60J 3/00

(52) U.S. Cl. CPC B60J 3/005

(57) ABSTRACT

A framed shade cassette window enclosure includes a channel defining a shade cassette enclosure, an outer flange positioned outward of the channel, and a recessed area defining a concave gap between the outer flange and the channel. The recessed area is sized to fit in a window opening.

### CROSS-REFERENCES TO RELATED APPLICATIONS

This application claims the benefit of U.S. Provisional Patent Application No. 63/514,003, filed Jul. 17, 2023, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a window frame and, more particularly, to a framed shade cassette window enclosure that is used as a clamp ring to hold the window into the wall opening and also encases a shade or screen cassette.

It is desirable to provide a shade or other window covering for recreational vehicle windows. Due to space limitations, however, various connectors, shrouds, and other structures are typically required to secure the shade assembly.

With recreational vehicle windows, it is also desirable to provide a clean and streamlined appearance.

### SUMMARY

An exterior frame extrusion mounts to a wall around a window opening and encloses the shade cassette. The window frame portion is shown as an exterior frame portion, but may be securable to an opposing inner/outer frame portion. The frame portion or extrusion includes a concave gap as viewed from the exterior of the frame or extrusion. The gap fits into the window opening and receives fasteners within the recess. The gap or recess is flanked by an outer flange to rest flush with the wall and a flange defining a shade enclosure. Trim may be mountable over the outer flange and recess to abut a side of the shade enclosure and overlie the outer flange without the fastener obstructing.

In an exemplary embodiment, a framed shade cassette window enclosure includes a channel defining a shade cassette enclosure, an outer flange positioned outward of the channel, and a recessed area defining a concave gap between the outer flange and the channel, wherein the recessed area is sized to fit in a window opening.

The enclosure may be square or rectangular and may include four sides, where the channel spans the four sides of the enclosure. The outer flange may extend across the four sides of the enclosure.

The framed shade cassette window enclosure may also include a plurality of fasteners disposed in the recessed area.

The window opening may define a window plane, and the channel may include a first section parallel with the window plane and a second section perpendicular to the window plane. The recessed area may include a U-shaped section with the second section of the channel, a recess bottom connected to the second section and parallel with the window plane, and an outer wall connected to the recess bottom and perpendicular to the window plane. The outer flange may be connected to the outer wall of the recessed area and may be parallel with the window plane. The outer wall of the recessed area may be shorter than the second section of the channel. The outer flange may be configured to sit flush on a wall adjacent the window opening.

The outer flange may be configured to sit flush on a wall adjacent the window opening.

The framed shade cassette window may include a shade cassette. The framed shade cassette window enclosure may include a trim kit that is positioned against an exterior of the channel and covers the recessed area and the outer flange.

In another exemplary embodiment, a framed shade cassette window enclosure includes a channel defining a shade cassette enclosure, an outer flange positioned outward of the channel, and a recessed area defining a concave gap between the outer flange and the channel. An opposite side of the recessed area defines a mounting trim ring sized to fit in a window opening. The channel, the outer flange and the recessed area define a single-piece frame member.

The single-piece frame member may be securable to an opposing inner/outer frame portion via a plurality of fasteners through the recessed area. The outer flange may extend from the recessed area in one direction and may be configured to rest flush with a wall surrounding the window opening, where the channel may include a flange section that extends from the recessed area in an opposite direction.

### BRIEF DESCRIPTION OF THE DRAWINGS

These and other aspects and advantages will be described in detail with reference to the accompanying drawings, in which:

FIG. 1 shows the framed shade cassette window enclosure separated from the shade cassette;

FIG. 2 shows the frame enclosure engaging the shade cassette;

FIG. 3 is a close-up view of a corner of the frame enclosure;

FIG. 4 is a perspective view of assembly;

FIG. 5 is a cross-sectional view of the assembly;

FIG. 6 shows the frame enclosure ready for installation over a window opening; and

FIG. 7 shows the installed enclosure including trim.

### DETAILED DESCRIPTION

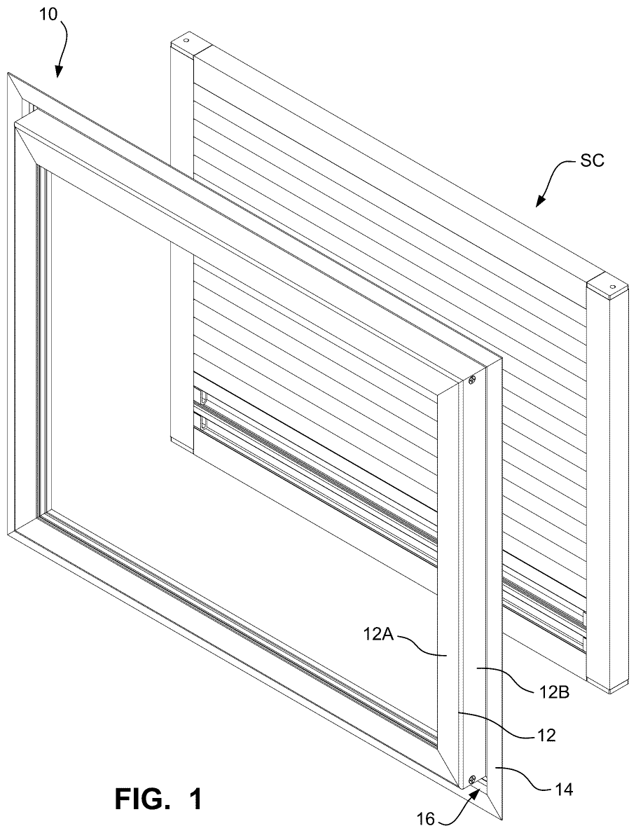

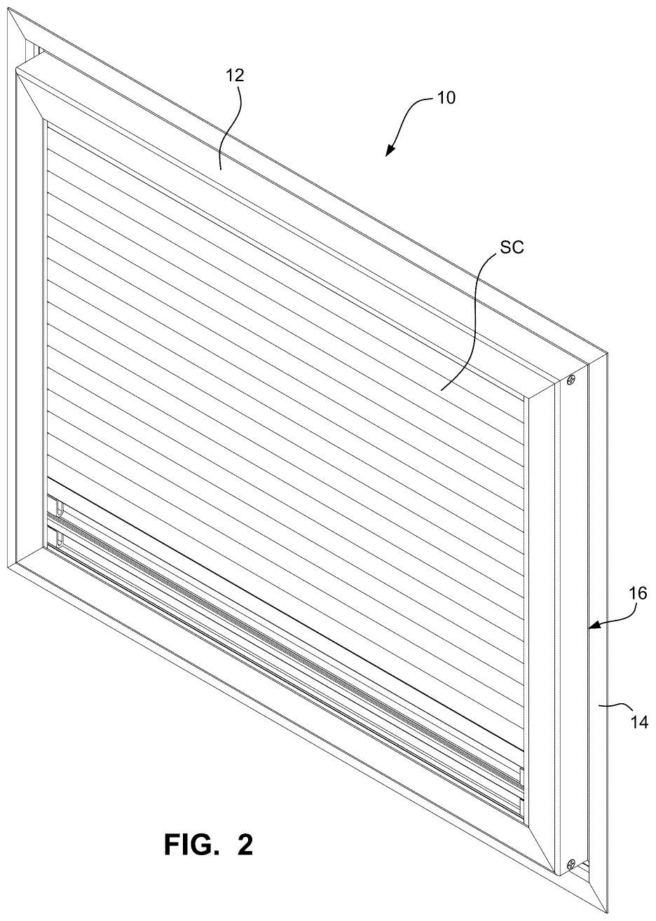

With reference to FIGS. 1-5, a framed shade cassette window enclosure 10 is securable in a window opening and secures a shade cassette SC. The enclosure 10 is essentially an exterior frame extrusion that mounts to the wall but also encloses the shade cassette SC.

The enclosure 10 includes a channel 12 that defines a shade cassette enclosure. An outer flange 14 is positioned outward of the channel 12, and a recessed area 16 defining a concave gap is disposed between the outer flange 14 and the channel 12. The recessed area 16 on a back side of the enclosure 10 defines a protrusion that is sized to fit in a window opening.

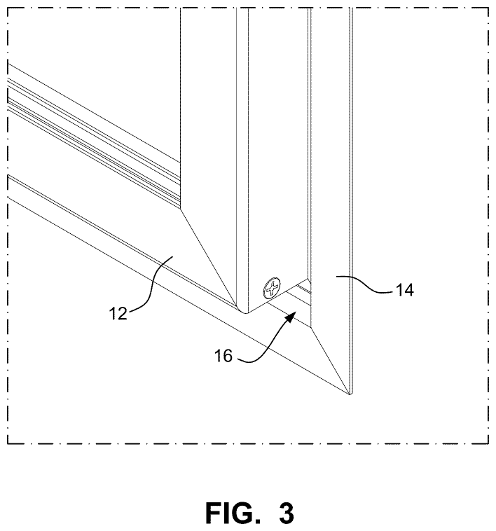

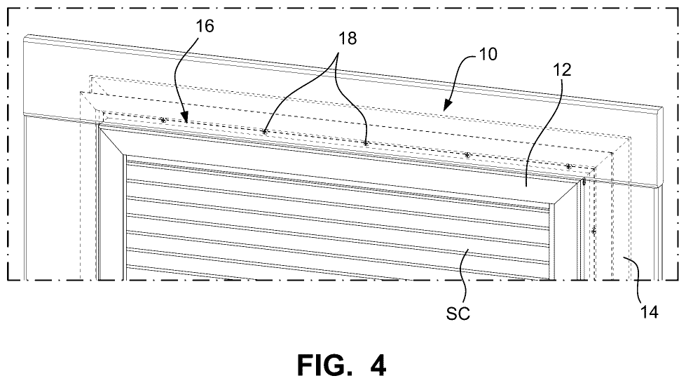

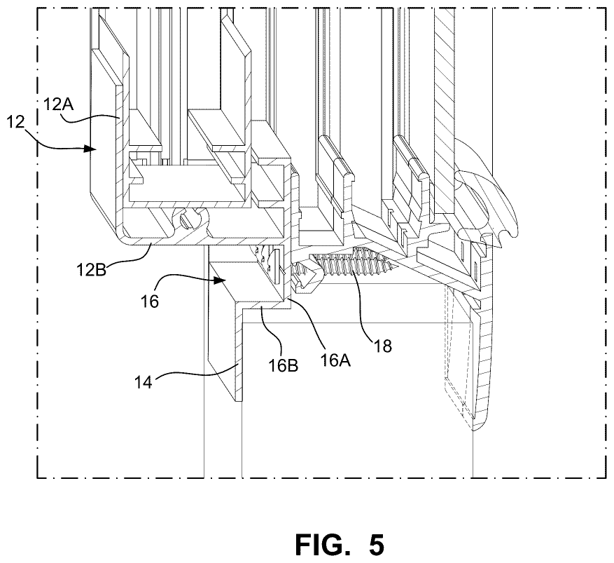

The channel 12 includes a first section or flange section 12A parallel with a window plane and a second section or depth section 12B perpendicular to the window plane. As shown in FIGS. 4 and 5, the recessed area 16 is a U-shaped section including the second section 12B of the channel 12, a recess bottom 16A connected to the second section 12B and parallel with the window plane, and an outer wall 16B connected to the recess bottom 16A and perpendicular to the window plane. The outer flange 14 is connected to the outer wall 16B of the recessed area 16 and is parallel with the window plane. In some embodiments, the outer wall 16B of the recessed area 16 is shorter than the second section 12B of the channel 12. As a consequence, with particular reference to FIG. 3, the outer flange 14 is offset from the first section 12A of the channel 12. The outer flange 14 is configured to sit flush on the wall adjacent the window opening.

In some embodiments, the enclosure 10 is square or rectangular with four sides. The channel 12 may span all four sides of the enclosure 10. Similarly, the outer flange 14 may extend across the four sides of the enclosure 10.

Fasteners 18 are extendable through the enclosure 10 in the recessed area 16. The enclosure 10 in the form of a frame or extrusion may be designed to interact with another half of the full frame assembly that bridges the gap between the interior and exterior faces of the wall opening to encase the window.

Shown in FIG. 5 in phantom is the wall and trim overlying the enclosure 10 as described above. The enclosure 10 is seen on the left side of the wall opening. In this view, the outer flange 14 is engaging the wall, and the recessed area 16 recesses inward to create the concave gap. A fastener 18 can be seen in this view connecting the exterior frame portion to the interior frame portion to bridge the wall opening.

The enclosure 10 then leads into the second section 12B of the channel 12 perpendicular to the concave gap to form the channel 12, which is housing a shade cassette SC adjacent the wall opening. The shade cassette SC could be any of many types of shade assemblies including pleated shades, a roller shade, or a dual shade/screen assembly.

In FIG. 5, it can be seen how the fasteners 18 connect the two frame members but are hidden in the recessed area 16. FIG. 5 also demonstrates how the fasteners 18 stay out of the way and out of sight in the installed state.

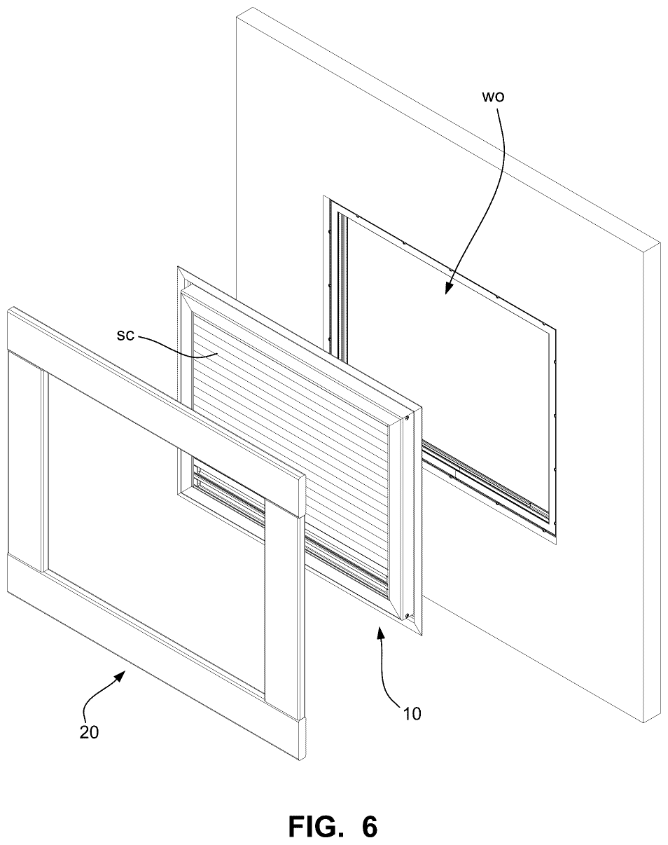

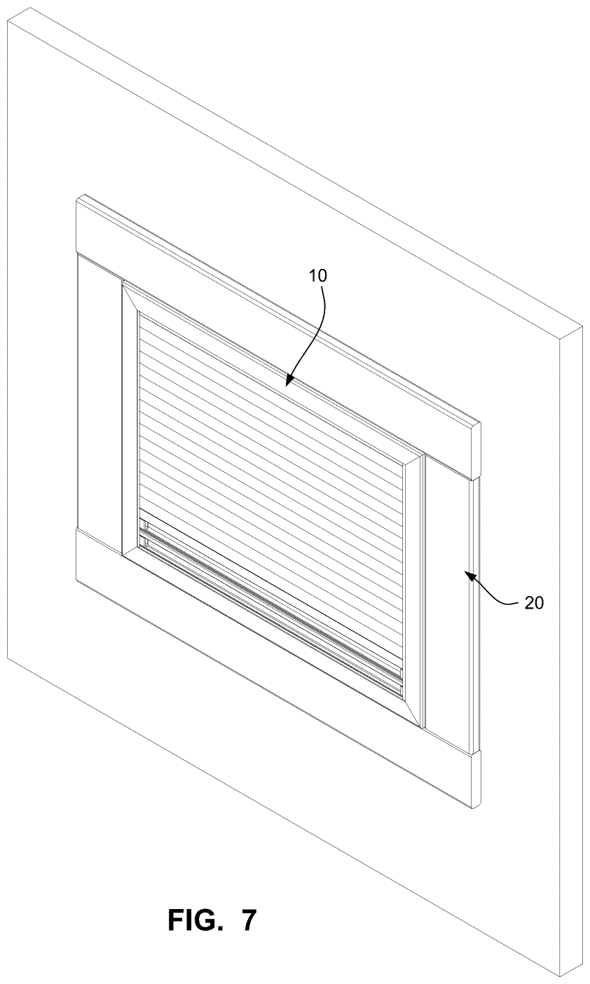

With reference to FIGS. 6 and 7, the enclosure 10 receives the shade cassette SC and is secured over the window opening WO via fasteners 18 or the like (not shown in FIG. 6). Once in place, a trim kit 20 may be positioned against an exterior of the channel 12 covering the recessed area 16 and the outer flange 14. This is assisted by the outer flange 14 being located intermediate to (i.e., offset from) the distance between the inner face of the recess/gap and the parallel flange defining the shade enclosure.

The enclosure 10 may be constructed in the form of a single-piece frame member including a mounting trim ring defined by an opposite side of the recessed area 16 and integral shade encasement defined by the channel 12. The enclosure 10 defines a window frame portion securable to an opposing inner/outer frame portion with a concave gap that fits into the window opening and receives fasteners within the recess, with the recess also flanked by flanges perpendicular to and forward from the recess opening. One of the flanges is the outer flange that is configured to rest flush with the wall, and the other flange defines the outer face of the shade enclosure.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A framed shade cassette window enclosure comprising:
a channel defining a shade cassette enclosure;
an outer flange positioned outward of the channel; and
a recessed area defining a concave gap between the outer flange and the channel, wherein the recessed area is sized to fit in a window opening.

2. A framed shade cassette window enclosure according to claim 1, wherein the enclosure is square or rectangular and comprises four sides, wherein the channel spans the four sides of the enclosure.

3. A framed shade cassette window enclosure according to claim 2, wherein the outer flange extends across the four sides of the enclosure.

4. A framed shade cassette window enclosure according to claim 1, further comprising a plurality of fasteners disposed in the recessed area.

5. A framed shade cassette window enclosure according to claim 1, wherein the window opening defines a window plane, wherein the channel comprises a first section parallel with the window plane and a second section perpendicular to the window plane.

6. A framed shade cassette window enclosure according to claim 5, wherein the recessed area comprises a U-shaped section including the second section of the channel, a recess bottom connected to the second section and parallel with the window plane, and an outer wall connected to the recess bottom and perpendicular to the window plane.

7. A framed shade cassette window enclosure according to claim 6, wherein the outer flange is connected to the outer wall of the recessed area and is parallel with the window plane.

8. A framed shade cassette window enclosure according to claim 7, wherein the outer wall of the recessed area is shorter than the second section of the channel.

9. A framed shade cassette window enclosure according to claim 7, wherein the outer flange is configured to sit flush on a wall adjacent the window opening.

10. A framed shade cassette window enclosure according to claim 1, wherein the outer flange is configured to sit flush on a wall adjacent the window opening.

11. A framed shade cassette window enclosure according to claim 1, further comprising a shade cassette.

12. A framed shade cassette window enclosure according to claim 1, further comprising a trim kit that is positioned against an exterior of the channel and covers the recessed area and the outer flange.

13. A framed shade cassette window enclosure comprising:
a channel defining a shade cassette enclosure;
an outer flange positioned outward of the channel; and
a recessed area defining a concave gap between the outer flange and the channel, an opposite side of the recessed area defining a mounting trim ring sized to fit in a window opening,
wherein the channel, the outer flange and the recessed area define a single-piece frame member.

14. A framed shade cassette window enclosure according to claim 13, wherein the single-piece frame member is securable to an opposing inner/outer frame portion via a plurality of fasteners through the recessed area.

15. A framed shade cassette window enclosure according to claim 14, wherein the outer flange extends from the recessed area in one direction and is configured to rest flush with a wall surrounding the window opening, and wherein the channel comprises a flange section that extends from the recessed area in an opposite direction.

16. A framed shade cassette window enclosure according to claim 13, wherein the window opening defines a window plane, wherein the channel comprises a first section parallel with the window plane and a second section perpendicular to the window plane.

17. A framed shade cassette window enclosure according to claim 16, wherein the recessed area comprises a U-shaped section including the second section of the channel, a recess bottom connected to the second section and parallel with the window plane, and an outer wall connected to the recess bottom and perpendicular to the window plane.

18. A framed shade cassette window enclosure according to claim 17, wherein the outer flange is connected to the outer wall of the recessed area and is parallel with the window plane.

19. A framed shade cassette window enclosure according to claim 18, wherein the outer wall of the recessed area is shorter than the second section of the channel.
